(19) United States
(12) Patent Application Publication
(10) Pub. No.: US 2026/0064091 A1
(43) Pub. Date: Mar. 5, 2026

(54) Method and Device for Determining Control Parameters for Controlling a Technical System

(71) Applicant: Robert Bosch GmbH, Stuttgart (DE)

(72) Inventors: Lukas Grossberger, Darmstadt (DE); Stefan Falkner, Blankenburg (DE)

(21) Appl. No.: 19/310,546

(22) Filed: Aug. 26, 2025

(30) Foreign Application Priority Data
Aug. 27, 2024 (DE) 10 2024 208 128.0

(51) Int. Cl. G05B 13/04; G05B 13/02

(52) U.S. Cl. CPC G05B 13/042; G05B 13/027

(57) ABSTRACT

A computer-implemented method for determining parameter values of parameters of an optimized parameter set for operating a particular technical system is disclosed. The behavior of the parameterized technical system can be simulated by way of operational variable profiles indicating time profiles of at least one input variable, at least one output variable and at least one status variable. The method includes the steps of providing a data-based representation model trained to associate operational variable time profiles of one or more technical systems with a latent representation vector in each case that characterizes the behavior of the technical system, and providing a data-based distribution model trained to associate latent representation vectors resulting from simulated operational variable profiles of the particular technical system with a probability distribution of parameter values of the parameters of the parameter sets. And the following steps are carried out iteratively (i) providing parameter values of an initial parameter set or selecting parameter values of a parameter set from a probability distribution of parameters by way of random selection, (ii) simulating or measuring the technical system parameterized with the parameter values of the parameter set in order to obtain operational variable time profiles, (iii) analyzing the obtained operational variable profile with the data-based representation model to obtain a latent representation vector, and (iv) further developing or retraining the data-based distribution model with a training data set from the obtained latent representation vector and the parameter set so that an updated probability distribution of parameters results from the data-based distribution model.

This application claims priority under 35 U.S. C. § 119 to application no. DE 10 2024 208 128.0, filed on Aug. 27, 2024 in Germany, the disclosure of which is incorporated herein by reference in its entirety.

The disclosure relates to controlled technical systems, and in particular to the design of controls for technical systems by way of suitable control parameterization.

### BACKGROUND

Technical systems, for example brake systems, and in particular functions such as ABS and ESP, hydraulic drives, as well as steering and lane assists, require control functions to ensure certain functionalities. These control functions are usually defined by indication of a function specification and a plurality of parameters, and are thus configured to the properties of the technical system to be controlled.

Frequently, the application, i.e. the parameterization of the control processes, is carried out manually by experienced application specialists. They often have years of experience with the technical system and the functions to be controlled. The control parameters are set for the application and the system behavior is subsequently tested.

Methods are already known that perform a parameterization using machine learning models, in particular variational autoencoders, in combination with Bayesian optimization, such as known from Antoine Grosnit et al., “High-Dimensional Bayesian Optimization with Variational Autoencoders and Deep Metric Learning,”https://arxiv.org/pdf/2106.03609.pdf. However, this procedure requires the explicit specification of a quality function for Bayesian optimization as well as consistent data dimensionality for the variational autoencoder.

In addition, the Bayesian optimization approach restricts the possible amount of simulation data that can be considered or severely restricts the expressive power of the learned embeddings.

Alternative strategies without unsupervised pre-training that only use simulation-based inference (SBI) approaches rely on so much simulated data that the required simulation time is rarely viable in practice.

It is the task of the present disclosure to provide an improved method for parameterization of control functions that combines the application process and in particular performs such process automatically.

### SUMMARY

This task is achieved with the method for parameterizing a control function for control of a technical system according to the description below as well as a corresponding device according to the description below.

Further embodiments are specified set forth below.

According to a first aspect, a computer-implemented method is provided for determining parameter values of parameters of an optimized parameter set for operating a particular technical system, wherein the parameter set particularly corresponds to control parameters, wherein the behavior of the parameterized technical system can be simulated by way of operational variable profiles indicating time profiles of at least one input variable, at least one output variable and at least one status variable, comprising the following steps:
providing a data-based representation model trained to associate operational variable time profiles of one or more technical systems with a latent representation vector in each case that characterizes the behavior of the technical system;
providing a data-based distribution model trained to associate latent representation vectors resulting from simulated operational variable profiles of the particular technical system with a probability distribution of parameter values of the parameters of the parameter sets; wherein the following steps are carried out iteratively:
providing parameter values of an initial parameter set or selecting parameter values of a parameter set from a probability distribution of parameters by way of random selection;
simulating or measuring the technical system parameterized with the parameter values of the parameter set in order to obtain operational variable time profiles;
analyzing the obtained operational variable profile with the data-based representation model to obtain a latent representation vector;
further developing or retraining the data-based distribution model with a training data set from the obtained latent representation vector and the parameter set so that an updated probability distribution of parameters results from the data-based distribution model.

Furthermore, the optimized parameter set can be determined based on the posterior probability distribution resulting from the further developed or retrained distribution model, wherein the parameter values of the optimized parameter set are determined to be those that are most likely to generate a predetermined reference behavior.

In addition, the representation model can be provided in the form of an encoder portion of a variational autoencoder configured as a recurrent or convolutional neural network or as a transformer network, and is trained in an unsupervised manner for a plurality of operational variable time profiles of various technical systems.

In order to enable the evaluation of time series of measurement data of different lengths representing the system behavior of a technical system with parameters of a particular parameter set, a variable autoencoder can be trained so that a latent representation vector with predefined dimensionality results for the particular parameter set. The time series of data may be determined by measurement or by way of a simulation. In other words, a physical model of the technical system and a control function that is parameterized according to the parameter set to be considered and time series data are determined. This time series data is used for unsupervised training of a variational autoencoder.

The latent representation vector may now be considered to be a low-dimensional representation of the parameters used. The latent representation vector serves to evaluate the subsequently simulated system behavior in relation to the reference behavior, which is provided in the form of simulated operational variable time profiles. For this purpose, a model is first created using a variational autoencoder that maps time series data to the latent representation vector for already parameterized technical systems. Generally, any variational autoencoder with recurrent or convolutional neural networks (including LSTM or GRU networks), or networks with transformer architectures, is suitable as a representation model.

Alternatively, the representation model may be configured as an MVTS transformer model with an imputation task, as disclosed in, for example, George Zerveas et al., “A Transformer-based Framework for Multivariate Time Series Representation Learning,” https://arxiv.org/abs/2010.02803.

Furthermore, the distribution model, in particular in the form of a flow matching posterior model or a posterior approximation model, can be trained with training data sets of latent representation vectors of the operational variable profiles and associated parameter values.

Pre-trained representation models allow data to be gathered in the form of operational variable profiles of a parameterized technical system from different sources and mapped in a latent representation vector. For a later application process, less data must then be collected or simulated accordingly, because the basic characteristic time series data has already been learned.

The latent representation vector may be used as a comparative measure between the desired and observed system behavior of the technical system.

In particular, a distance dimension to the latent representation vector can be used to perform an assessment of the analyzed parameterization.

Afterward, parameters for a parameter set are randomly selected from a prior distribution (or later posterior distribution).

Time series of operational variable profiles are determined by way of simulation or measurement for the randomly selected parameters.

The encoder portion of the previously trained variational autoencoder is used as a parameter model to determine a latent representation vector for the time series of operational variable profiles thus obtained. This allows the time series data to be represented in a fixed-sized vector.

The distribution model can be configured as a neural posterior estimation model, and which, in the case of latent representation vectors resulting from simulations of the particular technical system, indicates probability distributions of parameter values for the parameters.

Using the distribution model, a posterior probability distribution can be learned about possible parameter values closest to the reference behavior. The reference behavior corresponds to predetermined operational variable profiles that correspond to a desired behavior of a suitable parameterized technical system. The assessment is carried out based on the latent embedded operational variable profiles of the parameter sets that were already analyzed. From the learned posterior distribution, the parameter values for the next iteration are now randomly selected (drawn) and resimulated to perform the method iteratively. The representation model is used to again generate a latent representation vector of fixed length for the simulated time series of the operational variable profiles.

The distribution model in the form of the neural posterior estimation model is thus iteratively further trained and thus improves the posterior probability distribution for possible parameter values. This method is performed iteratively up to a predetermined termination condition (e.g., by reaching a predetermined maximum number of iterations). Next, the parameters of a parameter set most likely to generate the reference behavior may be applied to and evaluated on the target system.

Through pre-training of the representation model, previous application processes for one or more technical systems can be used for the parameterization of a new technical system. Many relationships known to experts are automatically trained in this manner. The representation model thus uses the general relationships between the behavior of a technical system parameterized with a particular parameter set and the corresponding parameter set as a reference in order to find the appropriate parameter set for a control process to be applied.

The method supports the creation of posterior probability functions for selecting parameter values for the parameter set with respect to the specific technical system to be applied so that the appropriate parameter set can be found by iteratively approximating the optimized parameter values. For this purpose, time series data is simulated in the form of operational variable profiles is simulated for the technical system in order to find parameter values for the parameter set sought based on the increasingly more accurate posterior probability distribution.

In contrast to prior art methods based on Bayesian optimization, an explicit specification of a quality function is not necessary and time series of different lengths can also be processed.

By suitably selecting the size of the latent representation vector, complex time series data can also be represented, but without the need for too many simulation runs, as is known for example in simulation-based inference methods.

### BRIEF DESCRIPTION OF THE DRAWINGS

Preferred embodiments are described in more detail below with reference to the accompanying drawings. The figures show:

FIG. 1 is a schematic illustration of a technical system with a control structure of a control loop;

FIG. 2 is a flow chart illustrating a method for optimizing parameter values of parameters for a particular technical system.

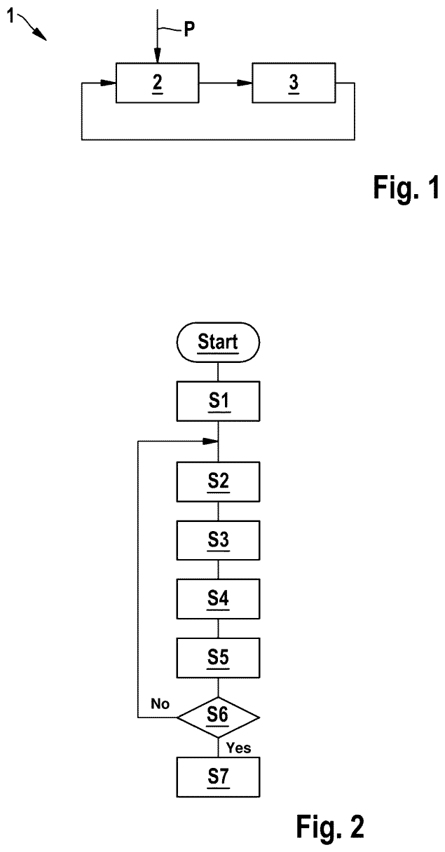

### DETAILED DESCRIPTION

A technical system 1, the function of which is determined by one or more parameters of a parameter set, is described below.

Examples of such systems may include a braking system having corresponding ABS and ESP functions, hydraulic drives, steering and lane keeping functions, which each have complex control structures adapted to the technical system. The control structure comprises a control function 2 with a parameter setting consisting of a plurality of parameters of a parameter set P and a control loop 3 corresponding to a technical device to be controlled.

For the implementation of a control for a novel function, a control function is usually initially specified, which must be parameterized by control parameters in an application process. The parameter determination is thus far performed manually or based on methods with Bayesian optimization, but which require the definition of a quality function, upon which selection the quality of the parameter set depends significantly.

A method is now used to parameterize the control function, as will be explained in more detail with the flow chart in FIG. 2.

In step S1, a pre-trained representation model is first provided for this purpose. The pre-trained representation model serves to provide system behaviors of a plurality of technical systems with various control functions that have already been parameterized in any way or in an optimized manner using other methods.

Various dynamic technical systems are therefore used as the basis, each having any or optimal parameterization, even though they have implemented different control functions. The system behavior is determined based on time series data of operational variables that map the dynamic system behavior. These operational variable time profiles may include input variables (control variables), output variables (manipulated variables), and measured or modeled status variables (such as temperature, pressure, speed, and the like) of the technical system.

To determine the representation model, the representation model is pre-trained with the time series data in an unsupervised manner using a variational autoencoder (as the encoder potion) or using a suitable generative model, such as an MVTS transformer model with an imputation task, as known from George Zerveas et al., “A Transformer-based Framework for Multivariate Time Series Representation Learning,” https://arxiv.org/abs/2010.02803. Thus, relevant characteristics of a plurality of technical systems can be depicted in a latent representation. These are provided as a low-dimensional latent representation vector.

The latent representation vector serves to evaluate the subsequently simulated system behavior in relation to the reference behavior, which is provided in the form of simulated operational variable profiles in each case.

Next, in step S2, initial parameter values of a parameter set (prior parameter set) are provided or parameter values are randomly selected from an already learned posterior probability distribution.

In step S3, the system behavior is simulated based on the parameter set provided or selected to obtain simulated operational variable profiles as time series data.

In step S4, the representation model is used to generate a latent representation vector for the operational variable profiles simulated from the simulation.

As a result, in step S5, a distribution model is trained or further developed, which can be configured as a neural posterior estimation model, for example. This model learns a posterior probability distribution about possible parameter values closest to the reference behavior. The neural posterior estimation model corresponds to a mapping of the latent vectors to parameter sets. The neural posterior estimation model must be inverted or conditioned to latent representations to predict a probability distribution across the possible values of a set of parameters.

The distribution model thereby maps the latent representation vectors to the parameter values of the parameter set. The training of the model occurs in a manner known per se. To go from the model that is trained to predict the latent representation from the parameters to a prediction about possible parameter values for a given reference behavior, the Bayes'theorem is used to invert the model so that the parameter values can be determined for a reference.

The method is iterated and the posterior model is further developed until a termination condition is satisfied, for example given by a maximum number of iterations, a maximum time duration of the optimization, and the like.

In step S6, the termination condition is checked accordingly. If the obtained parameter values are sufficiently optimized (alternative: yes), the method is continued with step S7. Otherwise (alternative: No), the method returns to step S2.

In step S2, the trained distribution model can now be used to determine parameter values (posterior) for the next iteration.

Afterward, in step S6, based on the posterior probability distribution resulting from the distribution model, those parameter values that are most likely to generate the reference behavior may be used to parameterize the control function. This may be the starting point for further adjustment of the parameter set based on expert knowledge.

What is claimed is:

1. A computer-implemented method for determining parameter values of parameters of an optimized parameter set for operating a particular technical system, wherein the behavior of the parameterized technical system can be simulated by way of operational variable profiles indicating time profiles of at least one input variable, at least one output variable and at least one status variable, the method comprising the following steps:
providing a data-based representation model trained to associate operational variable time profiles of one or more technical systems with a latent representation vector in each case that characterizes the behavior of the technical system;
providing a data-based distribution model trained to associate latent representation vectors resulting from simulated operational variable profiles of the particular technical system with a probability distribution of parameter values of the parameters of the parameter sets;
wherein the following steps are carried out iteratively:
providing parameter values of an initial parameter set or selecting parameter values of a parameter set from a probability distribution of parameters by way of random selection;
simulating or measuring the technical system parameterized with the parameter values of the parameter set in order to obtain operational variable time profiles;
analyzing the obtained operational variable profile with the data-based representation model to obtain a latent representation vector; and
further developing or retraining the data-based distribution model with a training data set from the obtained latent representation vector and the parameter set so that an updated probability distribution of parameters results from the data-based distribution model.

2. The method according to claim 1, further comprising:
determining the optimized parameter set based on the posterior probability distribution resulting from the further developed or retrained distribution model, wherein the parameter values of the optimized parameter set are determined to be those that are most likely to generate a predetermined reference behavior.

3. The method according to claim 1, wherein the representation model is provided in the form of an encoder portion of a variational autoencoder configured as a recurrent neural network or as a convolutional neural network or as a transformer network, and is trained in an unsupervised manner for a plurality of operational variable profiles of various technical systems.

4. The method according to claim 1, wherein the representational model is configured as an MVTS transformer model with an imputation task.

5. The method according to claim 1, wherein the distribution model, in the form of a flow matching posterior model or a posterior approximation model, is trained with training data sets of latent representation vectors of the operational variable profiles and associated parameter values.

6. The method of according to claim 1, wherein the distribution model is configured as a neural posterior estimation model, and which, in the case of latent representation vectors resulting from simulations of the particular technical system, indicates probability distributions of parameter values for the parameters.

7. A device for performing the method according to claim 1.

8. A computer program product comprising instructions which, when the program is executed by at least one data processing device, cause the data processing device to perform the steps of the method according to claim 1.

9. A machine-readable storage medium comprising commands which, when executed by at least one data processing device, cause the data processing device to perform the steps of the method according to claim 1.
